(19) United States
(12) Patent Application Publication
(10) Pub. No.: US 2005/0181180 A1
(43) Pub. Date: Aug. 18, 2005

(54) Large format metal mouse pad

(76) Inventors: Thomas J. Athanas, Austin, TX (US); Charles T. Athanas, Austin, TX (US); Marilyn A. Harrison, Austin, TX (US)

Correspondence Address: Rick B. Yeager, 10805 Mellow Lane, Austin, TX, 78759, US

(21) Appl. No.: 11/046,958

(22) Filed: Jan. 31, 2005

Related U.S. Application Data
(60) Provisional application No. 60/540,823, filed on Jan. 30, 2004.

(51) Int. Cl. G09G 5/08

(52) U.S. Cl. 428/172; 248/346.01; 248/918

(57) ABSTRACT

A large format aluminum mouse pad for competitive computer gamers. The pad has a hard anodized top surface that does not degrade over time. The pad may have convex side edges to increase play area, and a concave lower edge to permit faster wrist and hand movement. A non-skid pad may be provided to prevent the mouse pad from slipping. Low friction dots may be attached to the mouse to reduce sliding friction when the mouse is slid on the mouse pad. The mouse may be customized with laser engraving.

### RELATED APPLICATIONS

This application is related to U.S. Provisional Application No. 60/540,823 filed Jan. 30, 2004, and claims priority from that application.

### FIELD OF INVENTION

The current invention relates to a metal mouse pad for computer use, and more particularly to computer gaming use.

### BACKGROUND OF THE INVENTION

The computer mouse, either roller ball or optical, is a standard peripheral for personal computers and workstations. To facilitate the use of the computer mice, the mouse pad has also become a standard peripheral. Computer gaming has been growing since the invention of the personal computer. Currently, computer gaming is the largest single segment of the entertainment industry with a world-wide market size in excess of $36 Billion dollars. With the introduction of networking and the Internet, competitive computer gaming has become a large part of overall computer use.

The mouse pads featured in prior art normally have a surface of woven cloth, leather or plastic. While these surfaces are fine for the office or home computer user, they are not suitable for competitive computer gaming. Soft mouse pads, even those made from hard plastics wear and degrade over time. As a computer gamer uses his/her mouse pad, the tactile sensation between the gamer, the mouse and the prior art mouse pad changes. The change is gradual so the gamer typically does not notice the difference until the mouse pad is replaced. At that time, the accuracy that the computer gamer enjoyed through the interaction of the mouse with the mouse pad is lost. The computer garner is forced to adjust to a new interaction and game play suffers. The metal mouse pad of the current invention eliminates these type of problems found in prior art mouse pads.

U.S. Pat. No. 5,791,620 to Carich describes a soft format mouse pad with a transparent cover to display print material beneath it as a way of personalizing the mouse pad. The metal mouse pad of the present invention can be laser etched with custom art and text to provide permanent personalization. Neither the metal mouse pad or the laser etched art will wear.

U.S. Pat. No. 6,767,605 to Raciborski, describes a mouse pad that provides wrist support for the user. This method is very good for light mouse use, but does not work well for computer gamers. In one embodiment of the current invention, the metal mouse pad is provided with a concave bottom surface to prevent the computer gamers' wrist from contacting the metal mouse pad. This shape allows fast wrist and hand movement by the computer gamer which will enhance game play.

U.S. Pat. No. 4,799,054 by House describes a mouse pad which provides a hard plastic, textured surface. While this is an improvement from cloth and other soft surfaced mouse pads, this pad will still wear out and require replacement. In one embodiment, the metal mouse pad of the present invention is made of 5052-H32 Aluminum and hardened through an anodization process. This type of metal mouse pad will not wear out and will provide consistent tracking and feel.

### SUMMARY OF INVENTION

The metal mouse pad is typically anodized to provide a hard, durable, and consistent rolling surface for the mouse. The anodization may be provided in an attractive color.

The metal mouse pad may have a wide format. With a larger mouse pad, computer garners may lower their mouse sensitivity to gain extra control over the mouse movement within the computer game. The wide format allows the computer gamer the ability to turn his/her onscreen character 360 degrees within one horizontal pass over the surface of the metal mouse pad. Without the wide format, computer garners would be forced to lift their mouse off on the mouse pad surface and reposition it prior to completing the 360 degree turn. This not only slows down game play but forces the computer gamer to re-acquire targets within the computer game.

Computer garners personalize their gaming computers with sponsor logos and gaming symbols much like other sports do in showcasing sponsor logos on uniforms and sports equipment. The metal mouse pad can be laser etched with corporate logos, event logos and text.

A non-skid mat may be provided under the metal mouse pad. Low friction dots may be provided on the bottom of the mouse to reduce sliding friction.

One objective of the present invention is to provide a metal mouse pad which renders a long-lasting and consistent surface for the competitive computer gamer. Another objective is to provide a large format mouse pad, which allows the competitive computer gamer to decrease the sensitivity of the mouse for more accurate control. Another objective is to provide low-friction surface treatments which would facilitate easier mouse movements. Other objects and advantages will become apparent from consideration of the ensuing description in this application.

The metal mouse pad of the present invention is designed and manufactured for the competitive computer gamer. The metal mouse pad of the present invention will provide a playing surface that will not significantly wear down nor change with normal use of the product.

The metal mouse pad of the present invention provides the wide format needed by computer gamers to take advantage of more accurate mouse movement due to lowered mouse sensitivity.

The metal mouse pad of the present invention provides for a non-skid surface that prevents the metal mouse pad from moving during normal use and prevent the metal mouse pad from rocking on slightly irregular surfaces.

The metal mouse pad of the present invention provides a surface that be laser etched to personalize the metal mouse pad with text and artwork. The laser etched text and artwork will not faded or degrade with normal use.

### BRIEF DESCRIPTION OF DRAWINGS

FIG. 1 is a top view which shows shape details of one embodiment of a mouse pad and locations of markings such as product logo and optional corporate logos, event logos and text.

FIG. 2 is a side view which shows a metal mouse pad, a non-skid mat, and low friction dots on the bottom of the mouse.

### DETAILED DESCRIPTION OF EMBODIMENT—METAL MOUSE PAD

In this embodiment, the metal mouse pad base is laser cut with a YAG laser, from a solid piece of 0.090 inch 5052-H32 Aluminum. The 0.090 inch is a standard stock size for aluminum plate. Other thicknesses can be used, although it is generally desirable to use a thickness greater than 0.50 inches.

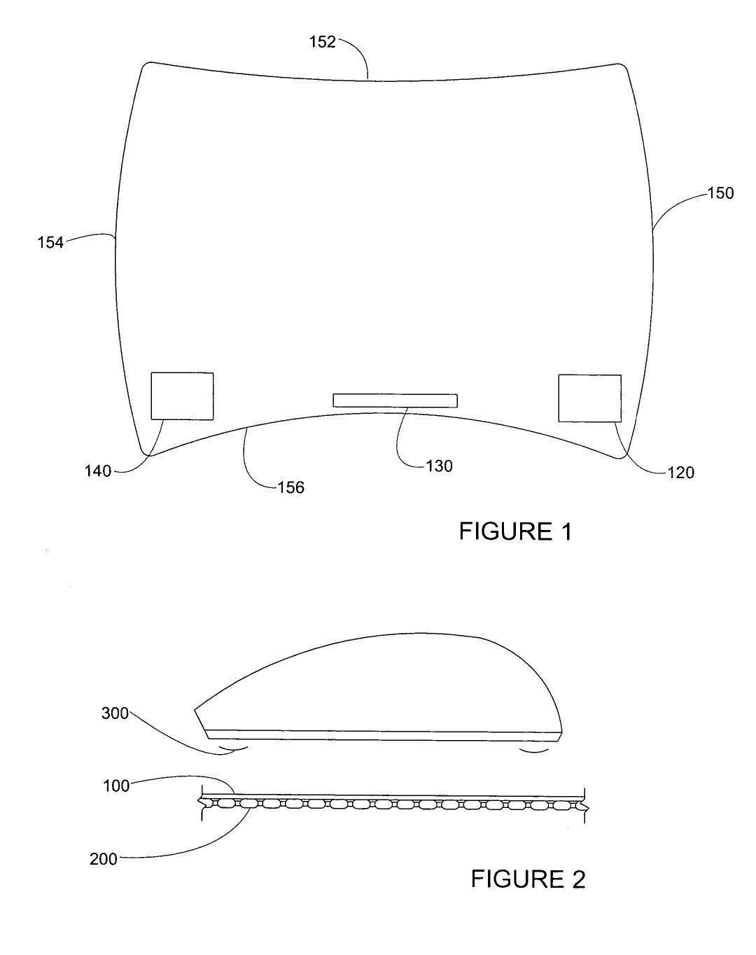

The shape may be a shape such as illustrated in FIG. 1 where the sides 154 and 150 of the mouse pad are convex. The convex side edges provide additional width to the mouse pad that permit computer garners the ability to lower their mouse sensitivity, which increases precision and enhances mouse control. The top edge 152 of the mouse pad is normally out of the active playing area, and may be curved for aesthetic reasons. The bottom edge 156 of the mouse pad has a concave shape to aid in keeping the computer garners' wrist from dragging on the mouse pad.

The metal playing surface is extremely durable and should not wear out with normal use. This gives the computer garner a consistent play and feel from the metal mouse pad.

### DETAILED DESCRIPTION OF EMBODIMENT—METHOD OF MANUFACTURE AND SURFACE FINISH

In this embodiment, after cutting the mouse pad to a desired shape, the metal mouse pad is placed into a jig and sanded with a jitterbug pattern using a hand-held pneumatic random orbital sander. The sanding is a two-step process, starting with 120 grit metal grade sand paper, and finishing with 220 grit metal grade sand paper. The edges 150, 152, 154, 156 of the mouse pad are slightly sanded to prevent burrs or sharp edges.

In one example, the mouse pad has an overall width of 14 inches, and an overall height of 10.5 inches. In other examples, the base may be larger or smaller, although it is generally desirable to provide a width of at least 10 inches and a height of at least 8 inches.

The metal mouse pad is then acid etched to further smooth the surface and to prepare the surface to receive an anodization. The anodization provides a hardened and attractive top surface. Typically, the anodization is applied to all surfaces.

The metal mouse pad is anodized in one of a variety of colors, such as red, blue, black, purple, gold, gray, or green.

The mouse pad may be customized for groups, events, or individual. For instance, FIG. 1 shows a placement 140 of a laser etched product logo. FIG. 1 also shows the location 130 of optional personalized text, such as a name or gamer handle that can be laser etched into the metal mouse pad. FIG. 1 shows the location 120 of optional additional art, such as company logos or event logos, that can be laser etched into the metal mouse pad.

### DETAILED DESCRIPTION OF EMBODIMENT—METAL MOUSE PAD WITH NON-SKID MAT

In one embodiment, the metal mouse pad may be provided with a separate non-skid, plastic coated fabric mat. In one example, the mat is die-cut 0.125″ smaller than the metal mouse pad.

FIG. 2 shows a non-skid mat 200 which provides friction grip of both the metal mouse pad 100 and the mouse support surface to prevent the metal mouse pad from moving during use. The non-skid mat, due to its thickness and softness, prevents the metal mouse pad from rocking should they be placed on a slightly irregular surface.

### DETAILED DESCRIPTION OF EMBODIMENT—METAL MOUSE PAD WITH LOW-FRICTION DOTS

In one embodiment, low-friction dots may be provided. In one example, the dots are 0.75 inch diameter discs which are made from 2 mil skived HD PTFE Tape with Silicone Adhesive DuPont Teflon.

FIG. 2 shows the low-friction dots 300 attached to the bottom of the mouse. The low friction dots lower the coefficient of drag between the mouse and the metal mouse pad. They also provide protection for the feet of the mouse and prevent the mouse feet from wearing out.

### DETAILED DESCRIPTION OF EMBODIMENT—ALTERNATIVE EMBODIMENTS

It will be obvious to one skilled in the art that various alternatives in design and material may be provided. For instance, the mouse pad may be constructed from other metals, including, but not limited to stainless steel or titanium.

The mouse pad may be made in other sizes such as a larger size or a smaller size.

The mouse pad may be made in other shapes to aid game play in other, yet-to-be released computer games.

The mouse pad may have alternate surface finish, such as a powder coating, instead of being anodized.

A small hole can be laser cut into any or all of the corners of the mouse pad to allow the mouse pad to be tethered. This would allow LAN Centers and Corporate Users (Trade Shows, Product Demonstrations, etc.) to use the mouse pad without fear of lost by theft.

1. A metal mouse pad comprising
a planar metal base, the base having a thickness of at least 0.060 inches, a width greater than 10 inches, and a height greater than 8 inches;
and a hardened top surface, such that the hardened top surface provides a durable and consistent surface for a computer mouse.

2. The mouse pad of claim 1 wherein
the metal base is aluminum; and
the hardened top surface is formed by anodizing the aluminum base.

3. The mouse pad of claim 1 wherein
the base has a thickness of about 0.090 inches, a width of about 14 inches, and a height of about 10.5 inches.

4. The mouse pad of claim 1 wherein
the hardened top surface is a powder coating.

5. The mouse pad of claim 1 wherein the base further comprises
a first convex side edge;
a second convex side edge; and
a concave bottom edge.

6. A method of making an anodized aluminum mouse pad, the method comprising
cutting an aluminum plate to form a base of a desired shape;
deburring the sides of the base; and
anodizing the aluminum to provide a hard top surface of the plate in a desired color.

7. The method of claim 6 further comprising
providing a laser marking on the top surface of the base.

8. A system for providing a mouse and mouse pad for computer gamers, the system comprising
a mouse pad support surface;
a non-skid pad positioned on the mouse pad support surface;
a metal mouse pad positioned on the non-skid pad, the metal mouse pad comprising
an aluminum base, the base having a having a thickness of at least 0.50 inches, a width greater than 10 inches, and a height greater than 8 inches, and an anodized top surface; and
a mouse, the mouse having a plurality of low friction dots, such that the low friction dots may slide on the metal mouse pad.

9. The system of claim 8 wherein
the base has a thickness of about 0.090 inches, a width of about 14 inches, and a height of about 10.5 inches.
